(19) United States
(12) Patent Application Publication
(10) Pub. No.: US 2008/0005250 A1
(43) Pub. Date: Jan. 3, 2008

(54) Messaging System and Related Methods

(76) Inventor: Ragip Dogan Oksum, Caddebostan (TR)

Correspondence Address: GORDON & JACOBSON, P.C., 60 LONG RIDGE ROAD, SUITE 407, STAMFORD, CT, 06902, US

(21) Appl. No.: 11/559,647

(22) Filed: Nov. 14, 2006

Related U.S. Application Data
(60) Provisional application No. 60/806,374, filed on Jun. 30, 2006.

(51) Int. Cl. G06F 15/16

(52) U.S. Cl. 709/206

(57) ABSTRACT

An electronic mail message system includes a database storing user information and electronic mail messages, and logic programmed to manage the content of the database, schedule the mailing of a delayed electronic mail message based on input from a remote user, and send one or more reminders to the remote user. The reminders indicate to the remote user the identity of the delayed electronic mail message stored in the database and when the delayed electronic mail message is scheduled for mailing or the fact that the delayed electronic mail message is not scheduled for mailing. Optionally, the electronic mail message is printed and delivered by post to the recipient in lieu of or in addition to the electronic mail. Optionally, the email, regular postal mail or SMS message sent to the recipient may only contain one or more hypertext links stored in one or more remote servers that can provide a reference to a private address which provides controlled access to the electronic mail message, text and/or attached files that are created (or uploaded) by the sender and intended for delivery to the recipient.

### CROSS-REFERENCE TO RELATED APPLICATIONS

This application claims benefits from U.S. Provisional Patent Application No. 60/806,374, filed Jun. 30, 2006, the contents of which are hereby incorporated herein by reference.

### BACKGROUND OF THE INVENTION

1. Field of the Invention

This invention relates broadly to internet communications. More particularly, this invention relates to web accessible systems utilizing electronic mail (email), cellular short message service (SMS) and regular postal mail.

2. State of the Art

Over the last 15 years, electronic mail has become an extremely popular form of communication for both business and personal purposes. The great advantages of electronic mail are: nearly instantaneous delivery, much less expensive than paper mail, saves paper and is thus environmentally friendly, easy and inexpensive to communicate with multiple correspondents at once, and there are usually at least two copies saved on two separate hard drives (i.e. easy to retrieve a copy if needed later). However, electronic mail does have some disadvantages. Nearly instantaneous delivery can be a disadvantage because it prompts nearly instantaneous action by the recipient and that may not always be desirable. The ease of use and low cost of electronic mail encourages more electronic mail which becomes time consuming for the recipients. The existence of multiple copies of an electronic mail message can also be a disadvantage because it interferes with document retention policies. Electronic mail can spread viruses and worms. In addition, the ease and low cost of electronic mail encourages the message author to send the message as soon as it is composed. Most everyone has, at one time or another sent an electronic mail message that they regret, a message that might not have been sent had they spent the time to think it over before sending it.

Sometimes it is desirable to send a regular postal mail message rather than an electronic mail message. A regular postal mail overcomes many of the disadvantages of electronic mail. Moreover, sometimes the person you want to communicate with does not have access to electronic mail. However, if the person is far away and/or if the message is lengthy, communication will be expensive.

Sometimes it is desirable to guarantee that only the intended recipient reads the message. It is however possible for someone other than the intended recipient to read the email or regular postal mail sent.

Sometimes it is desirable to get a message to a person as quickly as possible, but the person does not have access to electronic mail or a fax machine.

Sometimes it is desirable to delay or defer sending a composed electronic mail message or a regular postal mail message. While most electronic mail client software has the ability to save a draft for future sending, most people who have used this feature forget what is saved in the “drafts” folder and/or forget to send the draft. Moreover, when the computer is shut off or not connected to the internet, the saved draft of the email can not be sent.

### SUMMARY OF THE INVENTION

It is therefore an object of the invention to provide an electronic mail system where the sender can delay the sending (delivery) of electronic mail messages.

It is another object of the invention to provide an electronic mail system where the sender can schedule when a composed electronic mail message will be sent.

It is a further object of the invention to provide an electronic mail system which automatically reminds senders that draft electronic mail messages are waiting to be sent.

It is also an object of the invention to provide an electronic mail system which sends senders a confirmation message when a delayed electronic mail message or a regular postal mail message has been sent.

It is an additional object of the invention to provide a messaging system which automatically reminds senders that delayed electronic mail messages are scheduled to be sent and gives the senders the opportunity to cancel or reschedule or amend the electronic mail messages any time before it is sent.

It is still another object of the invention to provide an electronic mail system which will convert an electronic mail message to a regular postal mail message and deliver it by regular postal service.

It is another object of the invention to provide an electronic mail message system which will deliver the electronic message to a location close to the recipient, convert the electronic mail message to a regular postal mail message and deliver it by regular postal service local to the recipient.

It is a further object of the invention to provide an electronic mail message system which will convert electronic mail message attachments to a paper message and deliver it by regular postal service.

It is also an object of the invention to provide an electronic mail message system which will deliver the electronic message to a location close to the recipient, convert the electronic mail message to a paper message and deliver it to the recipient on the same day by regular postal service.

It is also an object of the invention to give an option to the sender to maximize the chances that only the intended recipient reads the message.

In accord with these objects, which will be discussed in detail below, a web-based electronic mail message system according to the invention is accessed by users (senders) using a web browser. The web browser connects to a web server where senders log on to their account using a name and a password (and/or other authentication means). The web server is coupled to an application server which is also coupled to a printer. The application server includes a database which stores sender information as well as electronic mail messages and attachments. It also contains logic for managing the database and for providing a user (the sender) interface according to the methods of the invention.

According to the methods of the invention, a sender logs onto the system and is presented with a number of options. These options include: compose an electronic mail message and review saved electronic mail messages. If the first option is chosen, the user (the sender) is presented with an electronic mail text editor which also has the option of attaching a document to the electronic mail message. When the user (the sender) has finished composing the electronic mail message, the user has several options. The sender may send the electronic mail message right away; schedule the electronic mail message for later mailing, or save the electronic mail message as a draft with no set mailing date. If the sender chooses to send the electronic mail message, either now or at a later date, the sender has more options. The sender can send the electronic mail message over the Internet, send it as regular postal mail, or send it as both. The send as regular postal mail option can also provide options as to how the regular postal mail is to be delivered, e.g. regular post, express post, overnight courier, or same day courier. If, after logging on, the sender chooses the second option (review saved messages), the sender is presented with a list of saved, yet to be sent, electronic mail messages or regular postal mail messages which also indicates the scheduled date of mailing if there is one. From here, the sender can edit, delete, schedule or reschedule any of the electronic mail messages or regular postal mail messages in the list. In the editing mode, the sender can also change the manner in which the electronic mail message is to be sent, and change the message or its attachments.

According to an aspect of the invention the sender may optionally choose that the mail sent to a recipient (either by email, regular postal mail or SMS) only contain hypertext links to a controlled private address where the message text and its attachments are stored in a remote secure server.

The management logic of the application server acts autonomously to loop through the database, determine when an electronic mail message or regular postal mail message is to be sent, determine how it is to be sent, and send the electronic mail message in the manner specified when it is due to be sent. The logic also preferably sends a message by email or SMS to the sender indicating that the electronic mail message or regular postal mail message was sent.

According to another aspect of the invention, the logic also sends one or more reminder messages by email or SMS to the sender indicating which electronic mail messages are scheduled for later mailing and what their scheduled mailing date is.

According to another aspect of the invention, the logic also sends one or more reminders to the sender indicating which electronic mail messages have been saved but are not scheduled for mailing. The reminders are preferably sent to the sender's conventional email address so that the sender does not need to log onto the system of the invention to be reminded. Alternatively the sender may be reminded by SMS directly to the sender's cellular phone.

The application server may be located at a single location and provided with one or more printers at that single location. In this case, all of the regular postal mail will be mailed from that same location. Optionally, the application server and/or printers may be distributed over many locations throughout the country or throughout the world. In this second case, the efficiency of regular postal mail delivery can be greatly optimized in terms of time and expense.

Additional objects and advantages of the invention will become apparent to those skilled in the art upon reference to the detailed description taken in conjunction with the provided figures.

### BRIEF DESCRIPTION OF THE DRAWINGS

FIG. 1 is a block diagram of a web based electronic mail messaging system in accordance with the present invention;

FIG. 2 is a schematic illustration of a user (the sender) interface according to the invention for composing a message, scheduling its mailing, and choosing the type of delivery;

FIG. 3 is a schematic illustration of a user (the sender) interface according to the invention for reviewing saved messaged; and

FIG. 4 is a flow chart illustrating the functionality provided by the scheduling process of FIG. 1 in accordance with the present invention.

### DETAILED DESCRIPTION

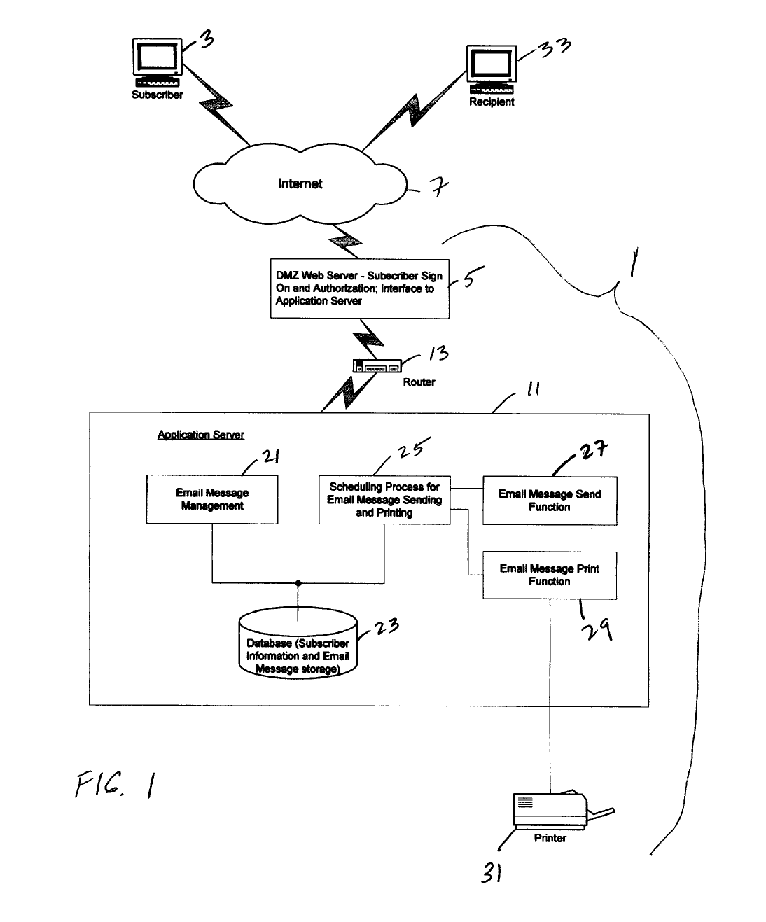

Turning now to FIG. 1, there is shown the architecture of an electronic mail messaging system 1 in accordance with the present invention. Senders (who are typically subscribers who pay a fee to access the system 1) utilize a web browser executing on a computing device 3 to connect to a web server 5 over the network 7 (e.g., Internet). Preferably, the browser-based interaction between the computing device 3 and the web server 5 occur over TCP/IP sessions established therebetween over which are communicated HTML-based (and possibly XML-based) commands, data and other messages. The web server 5 enables login and authentication of the sender via interaction with the user (the sender) system 3. Such login and authentication can utilize password-based authentication, operating system-based authentication (e.g., NTLM or Kerberos); services-based authentication (e.g., Microsoft Passport authentication), certificate-based authentication, or any other authentication scheme. Once a user (the sender) session has been authorized, the web server 5 communicates with an Application Server 11 to build dynamic web page(s) based on data supplied by the Application Server 11 and serve the dynamic web page(s) to the sender's web browser as requested, and forward (and/or transform) data supplied by the sender's web browser to the Application Server 11 as needed. Preferably, the web server 5 is located in a “demilitarized zone” (DMZ) provided with a firewall router 13. Note that there may be more than one Application Server 11 and firewall router 13 according to traffic. In, this configuration, the firewall/router 13 enables authorized communication between the web server 5 and the Application Server 11 (typically utilizing a secure socket layer (SSL) interface or an IPSec interface), while blocking unauthorized communication requests to the Application Server 11. In addition, the web server 5 preferably utilizes style sheets to build the HTML documents (also XML documents and ASPX documents) for presentment to the sender's web browser. The web server 5 may be realized by commercially available HTTP servers, such as the Apache Web Server, Microsoft Internet Information Server, and Sun ONE Web Server. According to the presently preferred embodiment, the Application Server 11 is at least partially implemented with Microsoft ASP.NET technology. It is however possible to implement the invention on other software and systems.

The Application Server 11 includes email message management logic 21, a database 23, a scheduling process 25, an email message send function 27 and a print function 29. The print function 29 is coupled to a printer 31. The message management logic 21 enables the sender to create or upload email messages, which may include text and/or one or more attached multimedia or any type of files (i.e., audio, still image, video, spreadsheet, database, 3-D graphic, etc.). Each email message includes header information that identifies i) the email address of the sender and ii) the email address or post office address (or both) of the recipient. For each email message created or uploaded by a particular sender, the particular sender can assign a mailing time (date and optionally hour:minutes) to the email message. The email messages as well as the mailing times associated therewith are stored in a database 23.

The email message management logic 21 also preferably enables a sender to select that a hard copy be mailed to the recipient of a particular email message as well as enables the sender to supply a postal address for the recipient. The indication to send a hard copy and the post office address data are stored in the database 23. In some cases, the email address of the recipient can be omitted. In these cases, the email message is not sent by email, but is sent only to the post office address by regular postal mail. Optionally, the regular postal mail delivery method may be selected among a number of options such as regular post, express post, overnight courier, or same day courier. In order to optimize the efficiency of paper mail delivery, a plurality of printers 31 may be located in different locations nationally or globally so that the paper message is printed at a location close to the recipient.

The email message management logic 21 also preferably enables a sender to request that delivery reminders be automatically generated and sent by the system. The indication that reminders are to be sent is stored in the database 23. The delivery reminders are email messages or SMS messages sent from the system to the sender's email address or cellular phone to provide a reminder notice regarding the future delivery of an email message stored and maintained by the system. The number of reminder messages and the timing of such reminder messages and as to be reminded by email and/or SMS are preferably set in accordance with sender input.

The scheduling process 25 accepts input from the sender as to when the message is to be mailed. At the scheduled time, the email message send function 27 and/or the print function 29 are activated. Reminders and confirmation notices are sent to the sender via email using the email send function 27 to the sender's email address. Optionally, these messages to the sender may be sent as SMS text messages, paper mail, etc.

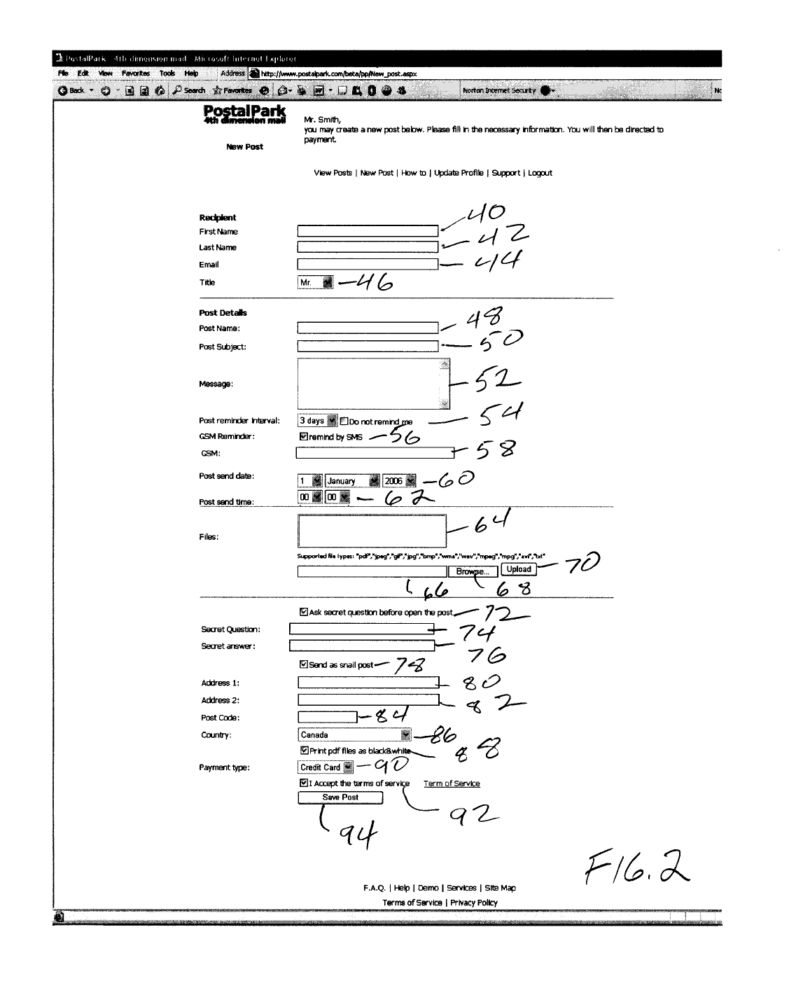

FIG. 2 illustrates a portion of the user interface of the invention, i.e. the compose and schedule message interface. From top to bottom, data entry fields are provided for data regarding the recipient, the message, the mailing date, and the manner of mailing. Specifically, fields are provided for the recipient's first name 40, last name 42, email address 44, and title 46. The message fields include a name field 48 (which is sent in the body of the message), a subject field 50, and a message body field 52. The reminder options are shown below the message body field. They include a reminder interval selection 54 which allows the sender to select one of number of reminder intervals (e.g., 1-2-3- . . . -29-30 days before the mailing date, etc.). If 8 days are chosen then the sender receives a reminder everyday starting 8 days before the mailing (for a total of 8 reminder messages). The sender may also customize the time period of the reminder messages and possibly the time interval between reminder messages. A check box is provided that allows the sender to select not to be reminded of the mailing of the electronic mail message. Alternatively, the time period and time intervals for reminder messages may be automatically calculated by the system. There is also a check box option 56 to be reminded by SMS and a field 58 for entering a GSM address (phone number) to which SMS messages will be sent. The mailing day month and year for the electronic mail message are selected using pull down fields 60 and the time of day for mailing is optionally selected with pull down fields 62. The database 23 stores data pertaining to the method of reminder delivery (email and/or SMS delivery) and the reminder interval and period of reminder messages for a given electronic mail message. The scheduling process 25 accesses such data as stored in the database 23 to generate and send the reminder message(s) for each given electronic mail message stored therein at the appropriate times and intervals. The reminder messages generated and sent by the system remind the senders that corresponding electronic mail messages are stored in the database 23 and are waiting to be sent.

One or more attachments can be added to the message using the text entry field 66 and the upload button 70. Local files at computer system 3 can be browsed using the browse button 68. The files which are attached to the message are shown in the box 64. The remaining fields involve password protection, postal delivery, and payment. If the check box 72 is checked, the recipient must supply the correct answer to a question entered in field 74 before the message and its attachments can be read. The correct answer is entered by the user (sender) in field 76. The database 23 stores data pertaining to the method of delivery (email and/or SMS delivery), the time period for reminder messages and possibly the time interval between reminder messages for a given electronic mail message. The scheduling process 25 accesses such data as stored in the database 23 to generate and send the reminder message(s) for each given electronic mail message stored therein at the appropriate times.

Check box 78 is provided that allows the sender to select whether or not the electronic mail message will be printed by printer 31 and delivered to the recipient by regular post. Fields 80, 82, 84, and 86 are used to enter the recipient's post office address and/or cellular number. The check box 88 instructs the system to print out attached files in black and white. If this box is not checked, the attachments will be printed in color. Payment type is selected at 90. Terms of service are agreed to with check box 92. The message is saved/sent with button 94. The database 23 stores data pertaining to the fields 78 through 88. The scheduling process 25 access such data as stored in the database to initiate the email print function 29 at the appropriate times, which causes the electronic mail messages to printed by the printer 31 in hard copy form as dictated by the sender. The hard copies of the electronic mail messages are placed in envelopes (by manual or automatic means) and placed into the postal mail for delivery to the postal address of the intended recipient.

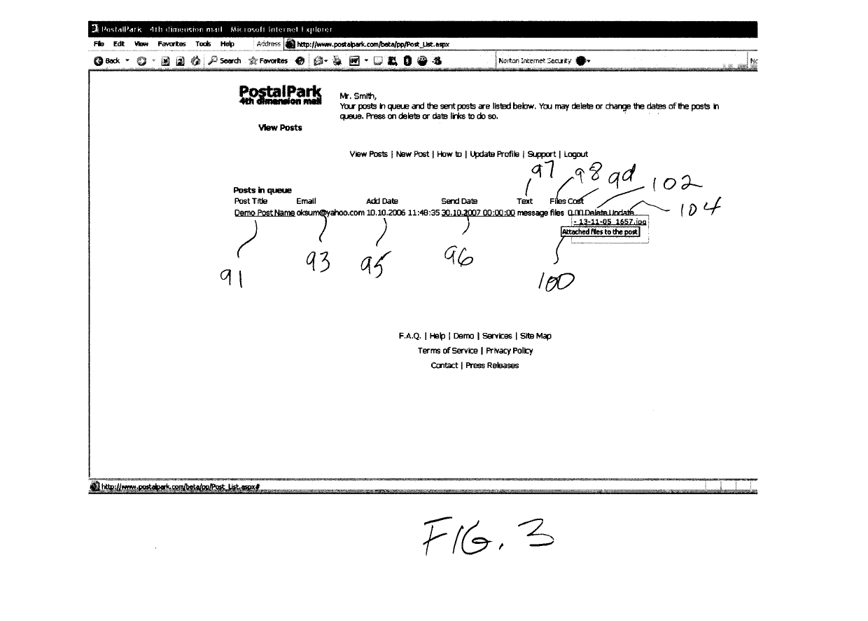

After a delayed electronic mail message has been saved, the sender can return to the system any time before the message is mailed and review the saved messages. FIG. 3 illustrates an example of a list of saved electronic mail messages waiting to be sent or waiting to be scheduled. The listing preferably includes identification 91 (same as 48) of the electronic mail message, email address 93 (same as 44) of the recipient, the date 95 the electronic mail message was added to the database, the scheduled mailing date 96, an indication and link 97 (same as 52) that the electronic mail message includes text, an indication and link 98 (same as 64) that the electronic mail message includes attached files, and an indication 99 of the cost for sending the electronic mail message. Using buttons 100, 102, and 104, the sender can view the electronic mail message and its attachments, delete the electronic mail message, or update the electronic mail message in terms of content or in terms of changing the delivery date.

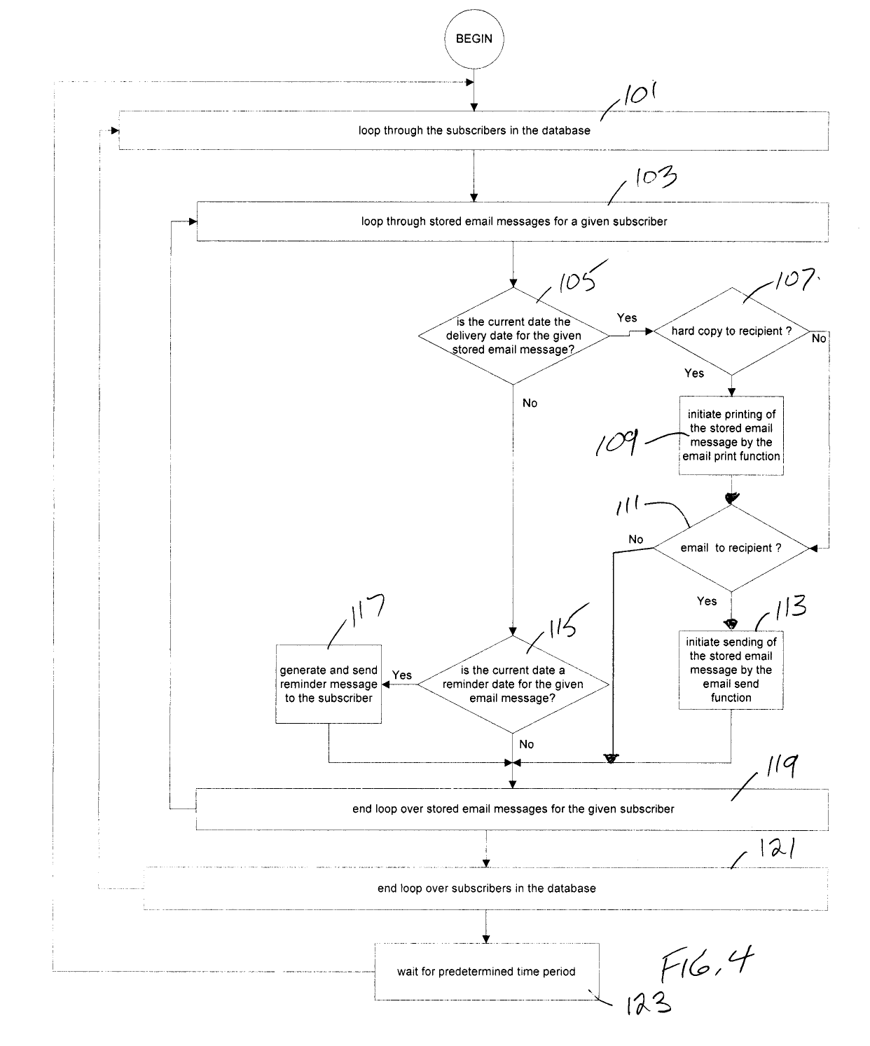

Referring once again to FIG. 1, after the sender has created an electronic mail message and saved it in the database 23, the scheduling function 25 runs autonomously as illustrated by the flow chart of FIG. 4. Referring now to FIGS. 1 and 4, the scheduling process 25 periodically cycles through the electronic mail messages stored in the database 23 of the system by cycling through the users (senders) at 101 and for each user (sender) cycling through stored messages at 103. The system automatically determines at 105 if any one of the stored messages should be mailed, i.e. the current date (and time if used) matches the delivery (mailing) date (and time if used) assigned to the message by the sender.

If the message should be mailed, the process 25 cooperates with email send function 27 and print function 29 to send the stored electronic mail message to the recipient by email, by regular mail, by SMS or by all. As shown in FIG. 4, it is determined at 107 whether a hard copy is to be delivered to the recipient. If it is, the print function 29 is initiated at 109. The hard copy print out is collected and placed into a suitable envelope for regular mail delivery to the postal address of the intended recipient. Preferably, the print function 29 cooperates with the printer 31 to print a label that identifies the name and postal address of the intended recipient so that it can be readily affixed to an envelope. Whether or not a hard copy is to be delivered, it is determined at 111 if the message is to be sent by electronic mail. If it is, the email send function 27 is initiated at 113. When the loop through messages for a given sender is complete the system moves to the next user at 119. When all of the users' (senders') mail has been checked, the process ends at 121 and waits for a predetermined period of time at 123 to repeat the process. Alternatively, the process need not wait and may begin again immediately.

The process 25 also periodically checks at 115 whether any reminder messages should be generated and sent at 117 to any users (senders) of the system.

The email message management function 21 also allows the user (sender) to access the system and update the user's (sender's) electronic mail messages stored in the database 23 (such as deleting the stored electronic mail message entirely, changing the text of a particular stored electronic mail message, removing a file from a particular stored electronic mail message or adding a file to a particular electronic mail message) as described above with reference to the user (sender) interface. The user (sender) can also update the information associated with a particular electronic mail message, such as scheduled mailing date (and optionally time), the sender's selection whether or not to send a hard copy print out, and/or the postal address of the recipient, the sender's selection whether or not to send hypertext links of the text and files instead of the text and files as attachments to the email and/or regular mail, the user's selection whether or not to encrypt or password protect the message, text and files. Such updates can be made at any time prior to the message's scheduled mailing date (and time if used).

The email message management function 21 also allows the sender (user) to access the system to update other pertinent information, such as information that dictates the number of delivery reminders and the time periods and time intervals for such reminders, payment information (e.g., credit card information), contact information including postal address and email address and SMS number of the sender, and information (i.e., a password or other information) used to authenticate the user (sender).

The Application Server 11 can perform additional tasks, such as email or SMS notification to a sender that the sender's scheduled electronic mail message has been sent and other reporting functions as well as archiving of sent electronic mail messages, text and files.

Optionally, the Application Server 11 can add one or more hypertext links to an electronic mail message that is sent to a recipient. In this case the electronic mail message does not have to include the message text and/or attached files. The hypertext link(s) can provide a reference to a private address that provides controlled access to an electronic mail message, text and/or attached files that are created (or uploaded) by a sender and intended for delivery to the recipient. The recipient can receive the electronic mail message and click on or copy-paste the hypertext link therein to access the content referred to by the link and download such content. In the preferred embodiment, such hypertext linking functionality is selectively activated by a given sender on a per email basis. If a sender optionally omitted the recipient email address, but provided the recipient post office address and selected that only a printed mail is sent to the post office address and also selected that the mail not include the message text and attached files, then the printed mail only includes one or more hypertext links described above. Then the recipient can type the printed hypertext link on a computing device 33 therein to access the content referred to by the link and download such content. Alternatively the sender may only provide the SMS of the recipient instead of the recipient's email or regular postal mail. Then the SMS only includes one or more hypertext links described above. Then the recipient can type the hypertext link at the SMS on a computing device 33 therein to access the content referred to by the link and download such content. Furthermore, access to the stored content can be protected by additional security mechanisms, such as requiring that the intended recipient answer a predetermined question to gain access the content referenced by the hypertext link. The predetermined question and the appropriate answer are provided by the sender and stored in the database. If the intended recipient fails to provide the appropriate answer, the Application Server 11 automatically denies access to the content referenced by the hypertext link. If the intended recipient does provide the appropriate answer, the Application Server 11 automatically grants access to the content referenced by the hypertext link.

There have been described and illustrated herein an embodiment of a system and methods for carrying out network-based electronic mail storage and delivery. While particular embodiments of the invention have been described, it is not intended that the invention be limited thereto, as it is intended that the invention be as broad in scope as the art will allow and that the specification be read likewise. Thus, while particular scheduling processes has been disclosed, it will be appreciated that other scheduling processes can be realized as well. Moreover, while particular authentication methodologies have been disclosed, it will be appreciated that other user authentication methodologies can be realized as well in order to support a number of users. Also, while preferred system architectures and underlying functional logic has been disclosed, it will be understood that modifications thereto can be similarly used. It will therefore be appreciated by those skilled in the art that yet other modifications could be made to the provided invention without deviating from its spirit and scope as claimed.

What is claimed is:

1. An electronic mail message system, comprising:
a database storing user information and electronic mail messages, and
logic coupled to said database and programmed to manage the content of the database based on input from a user located in a remote location, schedule the mailing of at least one electronic mail message based on input from the remote user, and send at least one reminder to the user, said reminder indicating at least one of
i) the identity of an electronic mail message stored in said database,
ii) when an electronic mail message stored in said database is scheduled for mailing, and
iii) the fact that an electronic mail message stored in said database is not scheduled for mailing.

2. A system according to claim 1, wherein:
said at least one reminder is a plurality of reminders.

3. A system according to claim 1, wherein:
the timing of said at least one reminder is selectable by the user.

4. A system according to claim 1, wherein:
said logic is programmed to calculate the timing of said at least one reminder.

5. A system according to claim 1, wherein:
said database stores user information for a plurality of users and electronic mail messages authored by a plurality of users.

6. A system according to claim 5, wherein:
said logic is programmed such that the electronic mail messages of a given user can be edited by the given user any time before being mailed.

7. A system according to claim 5, wherein:
said logic is programmed such that the electronic mail messages of a given user can be scheduled and rescheduled for mailing by the given user any time before being mailed.

8. A system according to claim 5, wherein:
said logic is programmed to send a given user a message when an electronic mail message of the given remote user is mailed, said message indicating that the electronic mail message was mailed.

9. A system according to claim 5, further comprising:
a printer coupled to said logic, said logic being programmed to print an electronic mail message of a given remote user in response to input from the remote user so that the printed electronic mail message can be delivered to a specified post office address in lieu of or in addition to electronic delivery of the electronic mail message.

10. A method for delivering messages, comprising:
receiving an electronic mail message from a user located in a remote location;
storing the message and any of its attachments in a database;
receiving recipient address information from the user;
receiving a delayed mailing time from the user; and
sending periodic reminders to the user, said periodic reminders indicating to the user the identity of the electronic mail message stored in the database and when the given electronic mail message is scheduled for mailing.

11. A method according to claim 10, further comprising:
receiving message edits from the user altering the content of the electronic mail message after it has been stored but prior to it being mailed.

12. A method according to claim 10, further comprising:
receiving, after the electronic mail message has been stored but prior to it being mailed, scheduling or rescheduling information from the user regarding when the electronic mail message is to be mailed.

13. A method according to claim 10, further comprising:
receiving delivery instructions from the user, the delivery instructions designating at least one of (i) instructions to send the electronic mail message by electronic means, and (ii) instructions to print the electronic mail message for deliver to the recipient's post office address, and (iii) instructions to send the electronic mail message for delivery to the recipient's SMS address.

14. A method according to claim 13, wherein:
the delivery instructions include (iv) instructions to send the electronic mail message by electronic means and to print the electronic mail message for delivery to the recipient's post office address.

15. A method according to claim 10, further comprising:
mailing the electronic mail message to the recipient at the delayed mailing time.

16. A method according to claim 13, wherein:
the message is printed at a location closer to the recipient than to the remote user.

17. A system for delivering messages, comprising:
a database storing user information and electronic mail messages;
logic coupled to said database and programmed to manage the content of the database based on input from a user located in a remote location, schedule the mailing of an electronic mail message to a recipient based on input from the user, and accept an instruction from the user to selectively print a paper copy of the electronic mail message so that the printed electronic mail message can be delivered to a specified post office address and store data pertaining to the instruction in said database;
at least one printer; and
scheduling logic that cooperates with said database and said at least one printer to print the paper copy of the electronic mail message at a scheduled mailing time in accordance with the data pertaining to the instruction as stored in said database.

18. A system according to claim 17, wherein:
said printer is located closer to the recipient than to the remote user.

19. A system according to claim 1, wherein:
the logic is adapted to generate and send a message to the intended recipient of an electronic mail message stored in the database, the message including at least one hypertext link that provides a reference to a private address that provides controlled access to at least a portion of the contents of the electronic mail message stored in the database.

20. A system according to claim 19, wherein:
the logic is adapted to require the intended recipient of the message to answer a question provided by the sender to gain access the portion of the contents of the electronic mail message stored in the database as referenced by the at least one hypertext link.

21. A system according to claim 19, wherein:
the hypertext link that provides a reference to a private address that provides controlled access to the text of the electronic mail message as stored in the database.

22. A system according to claim 19, wherein:
the hypertext link that provides a reference to a private address that provides controlled access to the attachments of the electronic mail message as stored in the database.

23. A system according to claim 19, wherein:
the message is communicated to the intended recipient as at least one of: an electronic mail message, an SMS message, and a regular postal mail item.
